(19) United States
(12) Patent Application Publication
(10) Pub. No.: US 2026/0254679 A1
(43) Pub. Date: Aug. 27, 2026

(54) CHARGE STEERING DIRECT-FEEDBACK DECISION FEEDBACK EQUALIZER (DFE)

(71) Applicant: QUALCOMM Incorporated, San Diego, CA (US)

(72) Inventor: Darius VALAEE, San Diego, CA (US)

(21) Appl. No.: 19/061,469

(22) Filed: Feb. 24, 2025

(51) Int. Cl. H04L 25/03

(52) U.S. Cl. CPC H04L 25/03057

(57) ABSTRACT

A method of decision feedback equalization includes receiving symbols at a first rate, converting the symbols into first bits and second bits using a first slicer and a second slicer, respectively, wherein each of the first and second slicers operates at a second rate approximately equal to half the first rate, alternately sampling the first bits using a first latch and a second latch, wherein each of the first and second latches operates at a third rate approximately equal to a quarter of the first rate, alternately sampling the second bits using a third latch and a fourth latch, wherein each of the third and fourth latches operates at the third rate, alternately coupling the first latch and the second latch to a feedback input of the second slicer, and alternately coupling the third latch and the fourth latch to a feedback input of the first slicer.

### BACKGROUND

### Field

Aspects of the present disclosure relate generally to equalizers, and more particularly, to decision feedback equalizers.

### BACKGROUND

In a system, data may be transmitted from a transmitter to a receiver across a channel (i.e., link). The data may be transmitted using symbols where each symbol carriers one or more bits. Because of non-idealities in the channel (e.g., attenuation at high frequencies), the incoming symbols at the receiver are distorted. The distortion may cause the symbols to spread into one another, resulting in intersymbol interference (ISI) at the receiver. The receiver may employ decision feedback equalization to compensate for the ISI.

### SUMMARY

The following presents a simplified summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

A first aspect relates to a decision feedback equalizer (DFE). The DFE includes a first slicer having a data input, a feedback input, and an output, wherein the data input of the first slicer is coupled to an input of the DFE, and a first demultiplexer having an input, a first output, and a second output, wherein the input of the first demultiplexer is coupled to the output of the first slicer. The DFE also includes a second slicer having a data input, a feedback input, and an output, wherein the data input of the second slicer is coupled to the input of the DFE, and a second demultiplexer having an input, a first output, and a second output, wherein the input of the second demultiplexer is coupled to the output of the second slicer. The DFE also includes a first multiplexer having a first input, a second input, and an output, wherein the first input of the first multiplexer is coupled to the first output of the second demultiplexer, the second input of the first multiplexer is coupled to the second output of the second demultiplexer, and the output of the first multiplexer is coupled to the feedback input of the first slicer. The DFE also includes a second multiplexer having a first input, a second input, and an output, wherein the first input of the second multiplexer is coupled to the first output of the first demultiplexer, the second input of the second multiplexer is coupled to the second output of the first demultiplexer, and the output of the second multiplexer is coupled to the feedback input of the second slicer.

A second aspect relates to a method of decision feedback equalization. The method includes receiving symbols at a first rate, and converting the symbols into first bits and second bits using a first slicer and a second slicer, respectively, wherein each of the first slicer and the second slicer operates at a second rate approximately equal to half the first rate. The method also includes alternately sampling the first bits using a first latch and a second latch, wherein each of the first latch and the second latch operates at a third rate approximately equal to a quarter of the first rate, and alternately sampling the second bits using a third latch and a fourth latch, wherein each of the third latch and the fourth latch operates at the third rate. The method also includes alternately coupling the first latch and the second latch to a feedback input of the second slicer, and alternately coupling the third latch and the fourth latch to a feedback input of the first slicer.

### BRIEF DESCRIPTION OF THE DRAWINGS

FIG. 1 shows an example of a system including a transmitter and a receiver according to certain aspects of the present disclosure.

FIG. 2 shows an example of distortion of a symbol caused by non-idealities in a link according to certain aspects of the present disclosure.

FIG. 3 shows an example of a decision feedback equalizer (DFE) using a half-rate clock according to certain aspects of the present disclosure.

FIG. 4 shows an exemplary implementation of a slicer according to certain aspects of the present disclosure.

FIG. 5A shows an example of a charge-steering (CS) latch during a reset phase according to certain aspects of the present disclosure.

FIG. 5B shows an example of the CS latch of FIG. 5A during a sampling phase according to certain aspects of the present disclosure.

FIG. 6A is a plot showing an example of output voltages of the CS latch according to certain aspects of the present disclosure.

FIG. 6B is a plot showing another example of output voltages of the CS latch according to certain aspects of the present disclosure.

FIG. 7 shows an example of a decision feedback equalizer (DFE) using a half-rate clock and a quarter-rate clock according to certain aspects of the present disclosure

FIG. 8 shows an exemplary implementation of a slicer including a feedback input according to certain aspects of the present disclosure.

FIG. 9A shows an example of a charge-steering (CS) multiplexer during a reset phase according to certain aspects of the present disclosure.

FIG. 9B shows an example of the CS multiplexer of FIG. 9A during a first select phase according to certain aspects of the present disclosure.

FIG. 9C shows an example of the CS multiplexer of FIG. 9A during a second select phase according to certain aspects of the present disclosure.

FIG. 10 is a flowchart illustrating a method of decision feedback equalization according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

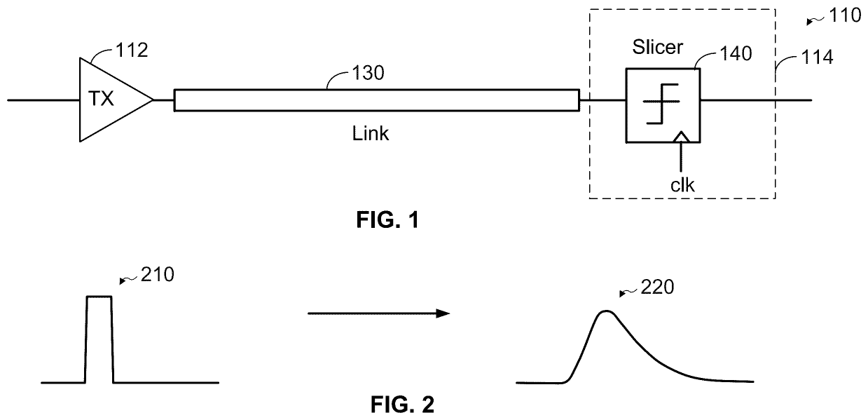

FIG. 1 shows an example of a system 110 in which data is transmitted from a transmitter 112 to a receiver 114 across a link 130 (e.g., a serial link). The transmitter 112 receives bits from a data source (not shown) and transmits the bits as a sequence of symbols across the link 130 (i.e., channel). At the receiver 114, a slicer 140 receives the symbols from the link 130 and converts the symbols into a sequence of bits (i.e., a bit stream). The bit stream may be sent to a processor or another circuit for further processing. It is to be appreciated that the receiver 114 may include one or more additional components not shown in FIG. 1 such as a continuous time linear equalizer (CTLE). The system 110 may also include a serializer at the transmitter side and a deserializer at the receiver side to support high-speed communication using serializer/deserializer (SerDes), a double-data rate (DDR) dynamic random-access memory (DRAM), and/or another circuit. The link 130 may be a single-ended link or a differential link.

As discussed above, the transmitter 112 may transmit bits as a sequence of symbols across the link 130. Each symbol may carry one or more bits depending on the modulation scheme used to convert the bits into symbols. Each symbol may be in the form of a pulse in which an amplitude (e.g., voltage) of the pulse represents a bit value (i.e., one or zero). The slicer 140 receives a symbol and makes a bit decision based on the received symbol to recover the respective bit. The bit decision may be made based on the voltage of the received symbol.

FIG. 2 shows an example in which the transmitter 112 transmits a symbol 210 representing a bit value of one across the link 130. As shown in FIG. 2, the symbol 220 received at the receiver 114 is distorted due to non-idealities in the link 130 (e.g., limited bandwidth of the link 130, reflections, etc.). In this example, the distortion spreads out the symbol 220 received at the receiver 114. This may cause the symbol 220 to spread into the next symbol (not shown) at the receiver 114, resulting in intersymbol interference (ISI).

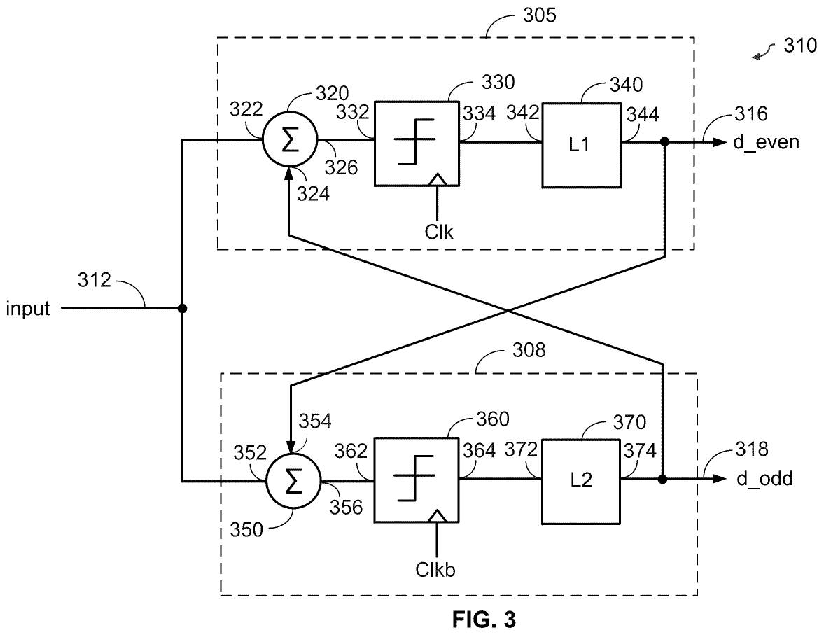

To reduce ISI, the receiver 114 may employ decision feedback equalization. In this regard, FIG. 3 shows an example of a decision feedback equalizer 310 configured to reduce ISI. In this example, the decision feedback equalizer 310 is implemented with a half-rate clock architecture including a first section 305 and a second section 308. Operations of the first section 305 and the second section 308 are timed based on a clock signal Clk having a frequency that is half the frequency of the incoming symbols (e.g., from the link 130). In this regard, the clock signal Clk may also be referred to as a half-rate clock signal. In this example, one period (i.e., cycle) of the clock signal Clk spans two symbol periods (i.e., two unit intervals (UIs)).

In this example, the decision feedback equalizer 310 has an input 312, a first output 316, and a second output 318. The input 312 may be coupled to the link 130 (shown in FIG. 1) to receive symbols from the transmitter 112 via the link 130. In certain aspects, the first section 305 is configured to process even symbols received at the input 312, and the second section 308 is configured to process odd symbols received at the input 312, or vice versa. In these aspects, the first section 305 and the second section 308 are time interleaved in which the first section 305 processes the even symbols and the second section 308 processes the odd symbols. The time interleaving allows each of the first section 305 and the second section 308 to operate using the half-rate clock signal, which relaxes timing requirements compared with using a full-rate clock.

In the example in FIG. 3, the first section 305 includes a first summer 320, a first slicer 330, and a first latch 340 for processing the even symbols. The second section 308 includes a second summer 350, a second slicer 360, and a second latch 370 for processing the odd symbols.

In the first section 305, the first summer 320 has a first input 322, a second input 324, and an output 326. The first input 322 is coupled to the input 312 of the decision feedback equalizer 310 to receive the even symbols. The second input 324 is coupled to the second latch 370 in the second section 308 to receive a previous bit decision, as discussed further below. The first summer 320 is configured to weigh the previous bit decision with a respective weight and sum the weighted previous bit decision with a current even symbol to generate an ISI compensated even symbol at the output 326. An ISI compensated symbol may also be referred to as an equalized symbol or another term. The weigh applied to the previous bit decision may be selected based on the characteristics of the link 130 (e.g., frequency response of the link 130) to compensate for ISI due to the link 130.

The first slicer 330 has an input 332 and an output 334. The input 332 is coupled to the output 326 of the first summer 320 to receive the ISI compensated even symbol. The first slicer 330 is clocked using the clock signal Clk. As discussed further below, the second slicer 360 is clocked using the inverse clock signal Clkb such that the first slicer 330 and the second slicer 360 operate in a time alternating fashion. The first slicer 330 is configured to make a bit decision based on the received ISI compensated even symbol and output the bit decision at the output 334 (e.g., a one bit or a zero bit). For example, the first slicer 330 may compare the voltage of the ISI compensated even symbol with a reference voltage and make the bit decision based on the comparison.

The first latch 340 has an input 342 and an output 344. The input 342 is coupled to the output 334 of the first slicer 330 to receive the bit decision, and the output 344 is coupled to the first output 316 of the decision feedback equalizer 310. The first latch 340 is configured to latch the received bit decision and output the latched bit decision at the first output 316. As discussed further below, the latched bit decision is fed back to the second section 308 to provide a previous bit decision for the second section 308.

In the second section 308, the second summer 350 has a first input 352, a second input 354, and an output 356. The first input 352 is coupled to the input 312 of the decision feedback equalizer 310 to receive the odd symbols. The second input 354 is coupled to the output 344 of the first latch 340 to receive a previous bit decision from the first section 305. The second summer 350 is configured to weigh the previous bit decision with a respective weight and sum the weighted previous bit decision with a current odd symbol to generate an ISI compensated odd symbol at the output 356.

The second slicer 360 has an input 362 and an output 364. The input 362 is coupled to the output 356 of the second summer 350 to receive the ISI compensated odd symbol. The second slicer 360 is clocked using the inverse clock signal Clkb, which is 180 degrees out of phase with the clock signal Clk. The second slicer 360 is configured to make a bit decision based on the received ISI compensated odd symbol and output the bit decision at the output 364 (i.e., a one bit or a zero bit). For example, the second slicer 360 may compare the voltage of the ISI compensated odd symbol with the reference voltage and make the bit decision based on the comparison.

The second latch 370 has an input 372 and an output 374. The input 372 is coupled to the output 364 of the second slicer 360 to receive the bit decision, and the output 374 is coupled to the second output 318 of the decision feedback equalizer 310. The second latch 370 is configured to latch the received bit decision from the second slicer 360 and output the latched bit decision at the second output 318. The output 374 of the second latch 370 is coupled to the second input 324 of the first summer 320, in which the latched bit decision from the second latch 370 is fed back to the first summer 320 to provide the previous bit decision for the first section 305.

As shown in FIG. 3, the decision feedback equalizer 310 outputs even bits (labeled “d_even”) at the first output 316 and outputs odd bits (labeled “d_odd”) at the second output 318. The decision feedback equalizer 310 may output one even bit and one odd bit for every two UIs where one UI is the period of one symbol. The even bits and the odd bits may be output to a processor or another circuit (e.g., deserializer) for further processing.

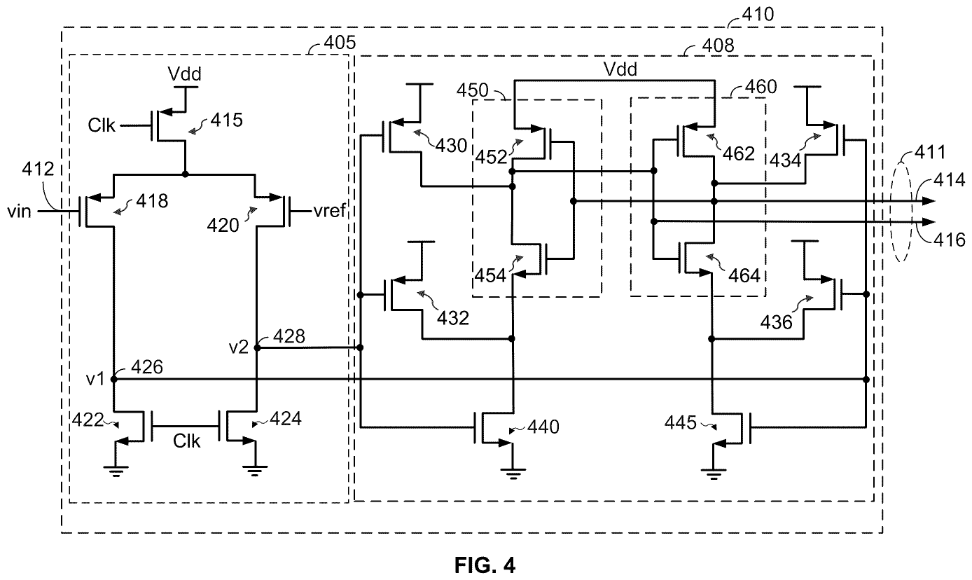

FIG. 4 shows an exemplary implementation of a slicer 410 according to certain aspects. Each of the first slicer 330 and the second slicer 360 may be implemented with the slicer 410 (i.e., each of the first slicer 330 and the second slicer 360 may be a separate instance of the slicer 410).

In this example, the slicer 410 includes an input stage 405 and a regeneration stage 408. The input stage 405 includes a first input transistor 418, a second input transistor 420, a first switching transistor 415, a second switching transistor 422, and a third switching transistor 424. As used herein, a “switching transistor” is a transistor used as a switch and may be driven by a clock signal or another type of signal.

In this example, the source of the first switching transistor 415 is coupled to the supply rail, and the gate of the first switching transistor 415 is driven by the clock signal Clk. The source of the first input transistor 418 is coupled to the drain of the first switching transistor 415, and the gate of the first input transistor 418 is coupled to an input 412 of the slicer 410. The source of the second input transistor 420 is coupled to the drain of the first switching transistor 415, and the gate of the second input transistor 420 is configured to receive a reference voltage (labeled “vref”).

The drain of the second switching transistor 422 is coupled to the drain of the first input transistor 418, the gate of the second switching transistor 422 is driven by the clock signal Clk, and the source of the second switching transistor 422 is coupled to ground. The drain of the third switching transistor 424 is coupled to the drain of the second input transistor 420, the gate of the third switching transistor 424 is driven by the clock signal Clk, and the source of the third switching transistor 424 is coupled to ground. The input stage 405 has a first node 426 between the first input transistor 418 and the second switching transistor 422 and a second node 428 between the second input transistor 420 and the third switching transistor 424.

In the example in FIG. 4, the first switching transistor 415 is implemented with a p-type field effect transistor (PFET) and each of the second switching transistor 422 and the third switching transistor 424 is implemented with a respective n-type field effect transistor (NFET). Also, each of the input transistors 418 and 420 is implemented with a respective PFET. However, it is to be appreciated that the present disclosure is not limited to this example.

The regeneration stage 408 includes a first inverter 450, a second inverter 460, a first transistor 440, second transistor 445, a third transistor 430, a fourth transistor 432, a fifth transistor 434, and a sixth transistor 436.

The first inverter 450 and the second inverter 460 are cross coupled in which the input of the first inverter 450 is coupled to the output of the second inverter 460, and the input of the second inverter 460 is coupled to the output of the first inverter 450. As discussed further below, the cross coupling of the first inverter 450 and the second inverter 460 provides regenerative feedback that allows the slicer 410 to resolve a bit (i.e., make a bit decision).

In this example, the first inverter 450 includes complementary transistors including an NFET 454 and a PFET 452, in which the drains of the NFET 454 and the PFET 452 are coupled to the output of the first inverter 450, the gates of the NFET 454 and the PFET 452 are coupled to the input of the first inverter 450, and the source of the PFET 452 is coupled to the supply rail. The second inverter 460 includes complementary transistors including an NFET 464 and a PFET 462, in which the drains of the NFET 464 and the PFET 462 are coupled to the output of the second inverter 460, the gates of the NFET 464 and the PFET 462 are coupled to the input of the second inverter 460, and the source of the PFET 462 is coupled to the supply rail.

The drain of the first transistor 440 is coupled to source of the NFET 454, the gate of the first transistor 440 is coupled to the second node 428 of the input stage 405, and the source of the first transistor 440 is coupled to ground. The drain of the second transistor 445 is coupled to the NFET 464, the gate of the second transistor 445 is coupled to the first node 426 of the input stage 405, and the source of the second transistor 445 is coupled to ground. In the example in FIG. 4, each of the transistors 440 and 445 is implemented with a respective NFET.

The source of the third transistor 430 is coupled to the supply rail, the gate of the third transistor 430 is coupled to the second node 428, and drain of the third transistor 430 is coupled to the output of the first inverter 450. The source of the fourth transistor 432 is coupled to the supply rail, the gate of the fourth transistor 432 is coupled to the second node 428, and the drain of the fourth transistor 432 is coupled to the source of the NFET 454 and the drain of the first transistor 440.

The source of the fifth transistor 434 is coupled to the supply rail, the gate of the fifth transistor 434 is coupled to the first node 426, and drain of the fifth transistor 434 is coupled to the output of the second inverter 460. The source of the sixth transistor 436 is coupled to the supply rail, the gate of the sixth transistor 436 is coupled to the first node 426, and the drain of the sixth transistor 436 is coupled to the source of the NFET 464 and the drain of the second transistor 445.

In the example in FIG. 4, the slicer 410 has a differential output 411 including a first output 414 coupled to the output of the second inverter 460 and a second output 416 coupled to the output of the first inverter 450.

Exemplary operations of the slicer 410 will now be discussed according to certain aspects. When the clock signal Clk is high, the slicer 410 is in a reset phase. During the reset phase, the first switching transistor 415 is turned off and the second switching transistor 422 and the third switching transistor 424 are turned on. As a result, the second switching transistor 422 and the third switching transistor 424 pull the first node 426 and the second node 428, respectively, to ground. The pulling down of the first node 426 and the second node 428 causes the transistors 430, 432, 434, and 436 in the regeneration stage 408 to turn on and reset the outputs of the inverters 450 and 460 to the supply voltage Vdd and reset the voltages at the drains of the first transistor 440 and the second transistor 445 to the supply voltage Vdd.

When the clock signal Clk transitions from high to low, the slicer 410 enters a sensing phase. During the sensing phase, the first switching transistor 415 turns on and the second switching transistor 422 and the third switching transistor 424 turn off. In this example, the voltage (labeled “vin”) of a symbol at the input 412 is input to the gate of the first input transistor 418 and the reference voltage (labeled “vref”) is input to the gate of the second input transistor 420.

If the voltage of the symbol at the input 412 is greater than the reference voltage, then the second input transistor 420 pulls the second node 428 high at a faster rate than the first node 426. As a result, the voltage (labeled “v2”) at the second node 428 rises faster than the voltage (labeled “v1”) at the first node 426 in this case. When the voltage at the second node 428 reaches the threshold voltage of the first transistor 440, the first transistor 440 turns on and pulls the source of the NFET 454 of the first inverter 450 to ground. This causes the first inverter 450 to turn on and pull the output of the first inverter 450 low. Since the output of the first inverter 450 (which is low) is cross coupled to the input of the second inverter 460, this causes the second inverter 460 to pull its output high (e.g., Vdd). In this case, the first output 414 is pulled high and the second output 416 is pulled low.

If, on the other hand, the voltage (labeled “vin”) of the symbol at the input 412 is less than the reference voltage (labeled “vref”), then the first input transistor 418 pulls the first node 426 high at a faster rate than the second node 428. As a result, the voltage (labeled “v1”) at the first node 426 rises faster than the voltage (labeled “v2”) at the second node 428 in this case. When the voltage at the first node 426 reaches the threshold voltage of the second transistor 445, the second transistor 445 turns on and pulls the source of the NFET 464 of the second inverter 460 to ground. This causes the second inverter 460 to turn on and pull the output of the second inverter 460 low. Since the output of the second inverter 460 (which is low) is cross coupled to the input of the first inverter 450, this causes the first inverter 450 to pull its output high (e.g., Vdd). In this case, the second output 416 is pulled high and the first output 414 is pulled low.

Thus, the regeneration stage 408 resolves a bit based on the voltage (labeled “v1”) at the first node 426 and the voltage (labeled “v2”) at the second node 428, and outputs the resolved bit at the differential output of the 411 of the slicer 410. The resolved bit has a bit value of one when the first output 414 is pulled high and the second output 416 is pulled low and a bit value of zero when first output 414 is pulled low and the second output 416 is pulled high, or vice versa. It is to be appreciated that the regeneration stage 408 is not limited to the exemplary implementation shown in FIG. 4.

In the example discussed above, the input 412 of the slicer 410 is a single-ended input in which the voltage (labeled “vin”) at the input 412 is compared with the reference voltage (labeled “vref”). However, it is to be appreciated that input 412 of the slicer 410 is not limited to this example. For example, in other implementations, the input 412 may be a differential input including a first input coupled to the gate of the first input transistor 418 and a second input coupled to the gate of the second input transistor 420.

As discussed above, the exemplary slicer 410 may be used to implement the first slicer 330 and the second slicer 360. For the first slicer 330, the gates of the switching transistors 415, 422, and 424 are driven by the clock signal Clk, the input 412 corresponds to the input 332, and the differential output 411 corresponds to the output 334. For the second slicer 360, the gates of the switching transistors 415, 422, and 424 are driven by the inverse clock signal Clkb, the input 412 correspond to the input 362, and the differential output 411 corresponds to the output 364.

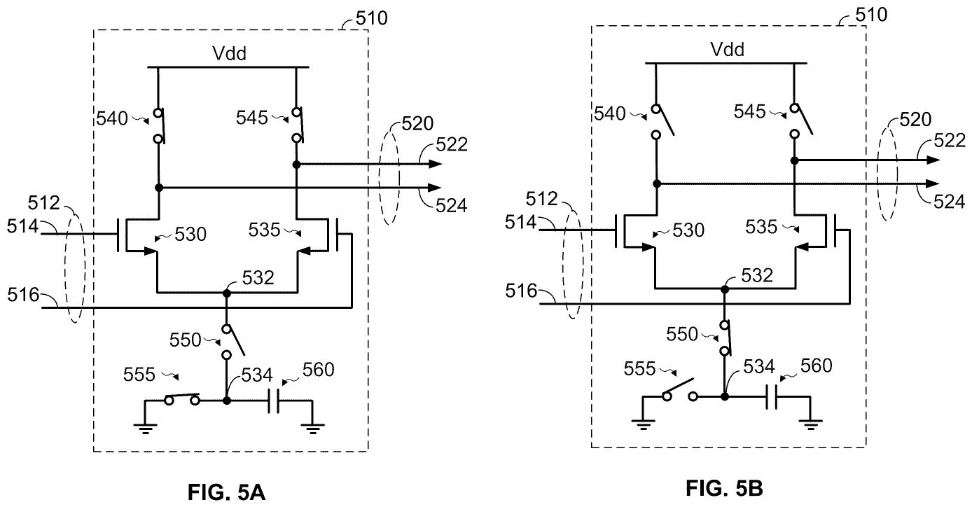

FIGS. 5A and 5B shows an exemplary implementation of a charge-steering (CS) latch 510 according to certain aspects. Each of the first latch 340 and the second latch 370 may be implemented with the CS latch 510 (i.e., each of the first latch 340 and the second latch 370 may be a separate instance of the CS latch 510).

The CS latch 510 includes a first switch 540, a second switch 545, a first input transistor 530, a second input transistor 535, a third switch 550, a fourth switch 555, and a capacitor 560 (also referred to as a tail capacitor). In the example shown in FIGS. 5A and 5B, each of the input transistors 530 and 535 is implemented with a respective NFET. Each of the switches 540, 545, 550, and 555 may be implemented with a respective transistor, a respective transmission gate, etc.

In the example shown in FIGS. 5A and 5B, the CS latch 510 has a differential input 512 including a first input 514 and a second input 516. The first input 514 may be coupled to the first output 414 of the slicer 410 and the second input 516 may be coupled to the second output 416 of the slicer 410, or vice versa. The CS latch 510 also has a differential output 520 including a first output 522 and a second output 524.

The first switch 540 is coupled between the supply rail and the drain of the first input transistor 530, and the second switch 545 is coupled between the supply rail and the drain of the second input transistor 535. The gate of the first input transistor 530 is coupled to the first input 514, and the gate of the second input transistor 535 is coupled to the second input 516. The sources of the input transistors 530 and 535 are coupled to a common node 532. The third switch 550 is coupled between the node 532 and node 534, the capacitor 560 is coupled between the node 534 and ground, and the fourth switch 555 is coupled between the node 534 and ground. The first output 522 is coupled between the second switch 545 and the drain of the second input transistor 535, and the second output 524 is coupled between the first switch 540 and the drain of the first input transistor 530.

Exemplary operations of the CS latch 510 will now be discussed according to certain aspects. FIG. 5A shows the CS latch 510 during a reset phase and FIG. 5B shows the CS latch 510 during a sampling phase. During the reset phase, the first switch 540, the second switch 545, and the fourth switch 555 are turned on (i.e., closed) and the third switch 550 is turned off (i.e., open). As a result, the first output 522 and the second output 524 are pulled to the supply voltage Vdd through the first switch 540 and the second switch 545. Thus, the first output 522 and the second output 524 are precharged to Vdd. Also, the capacitor 560 is discharged to approximately ground through the fourth switch 555.

During the sampling phase, the first switch 540, the second switch 545, and the fourth switch 555 are turned off (i.e., open) and the third switch 550 is turned on (i.e., closed). As a result, the node 532 is coupled to the capacitor 560, which is initially discharged. The first input transistor 530 conducts a first current based on the voltage at the first input 514, and the second input transistor 535 conducts a second current based on the voltage at the second input 516. The first current pulls down the second output 524 by discharging the capacitance at the second output 524 and the second current pulls down the first output 522 by discharging the capacitance at the first output 522. Assuming the voltages at the first input 514 and the second input 516 are different, the first output 522 and the second output 524 are pulled down at different rates.

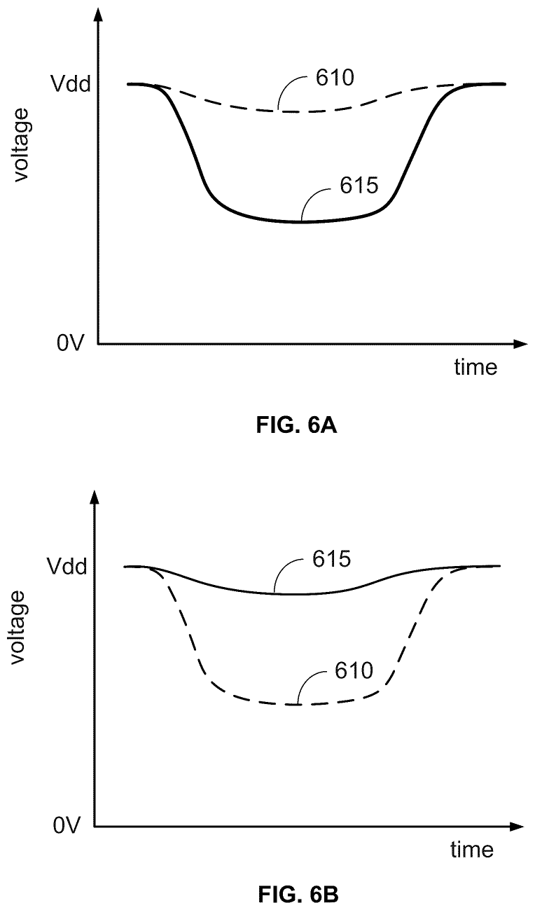

For example, when the voltage at the first input 514 is greater than the voltage at the second input 516, the first current flowing through the first input transistor 530 is greater than the second current flowing through the second input transistor 535. As a result, the second output 524 is pulled down at a faster rate than the first output 522. An example of this is illustrated in FIG. 6A, which shows a plot of the voltage 610 at the first output 522 and the voltage 615 at the second output 524 during the sampling phase. In this example, the voltage 615 at the second output 524 is pulled down faster than the voltage 610 at the first output 522, which produces a voltage difference between the first output 522 and the second output 524.

During the sampling phase, the currents flowing through the input transistors 530 and 535 charge the capacitor 560, which causes the capacitor 560 to raise the voltage at the node 532, which is coupled to the sources of the input transistor 530 and 535. Eventually, the voltage at the node 532 is raised high enough to turn off the input transistors 530 and 535, which prevents the voltages 610 and 615 from falling farther. As shown in FIG. 6A, this prevents the voltage 615 from falling all the way to ground potential and reduces the voltage swing at the outputs 522 and 524. As a result, the CS latch 510 does not require a full output voltage swing. The smaller output voltage swing at the outputs 522 and 524 relaxes timing margins, reduces power consumption, and enables faster operation.

During the next reset phase, the voltages 610 and 615 at the outputs 522 and 524 are precharged back to the supply voltage Vdd by the switches 540 and 545, as shown in FIG. 6A.

FIG. 6B shows a plot of the voltage 610 at the first output 522 and the voltage 615 at the second output 524 during the sampling phase for the case where the voltage at the second input 516 is greater than the voltage at the first input 514. In this case, the voltage 610 at the first output 522 falls lower than the voltage 615 at the second output 524.

In this example, the voltages 610 and 615 at the outputs 522 and 524, respectively, of the CS latch 510 represent a bit value of one or zero depending on whether the voltage 610 at the first output 522 is greater than or less than the voltage 615 at the second output 524. In other words, the voltages 610 and 615 provide a differential voltage in which the polarity of the differential voltage presents the bit value. For example, the voltages 610 and 615 may represent a bit value of one when the voltage 610 at the first output 522 is greater than the voltage 615 at the second output 524, and the voltages 610 and 615 may represent a bit value of zero when the voltage 610 at the first output 522 is less than the voltage 615 at the second output 524. However, it is to be appreciated that the present disclosure is not limited to this example.

In this example, the switching of the switches 540, 545, 550, and 555 may be timed using a clock signal that causes the CS latch 510 to cycle through the reset phase and the sampling phase during each period of the clock signal. For example, for a half-rate clock architecture, the switching of the switches 540, 545, 550, and 555 may be timed based a half-rate clock signal, which may be the same as the clock signal Clk or different from the clock signal Clk. However, it is to be appreciated that the CS latch 510 is not limited to a half-rate clock signal, as discussed further below.

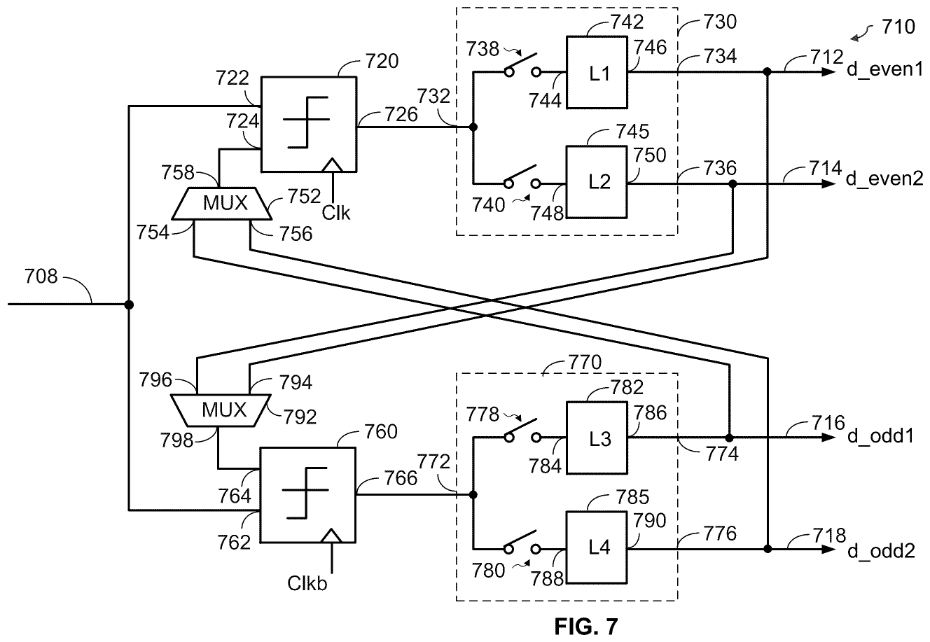

FIG. 7 shows an example of a decision feedback equalizer 710 that uses both a half-rate clock and a quarter-rate clock to time operations in the decision feedback equalizer 710, as discussed further.

In this example, the decision feedback equalizer 710 has an input 708, a first output 712, a second output 714, a third output 716, and a fourth output 718. The input 708 may be coupled to the link 130 (shown in FIG. 1) to receive symbols from the transmitter 112 via the link 130. The input 708 may be a single-ended input or a differential input. Each of the outputs 712, 714, 716, and 718 may be a single-ended output or a differential output.

The decision feedback equalizer 710 includes a first slicer 720, a second slicer 760, a first demultiplexer 730, a second demultiplexer 770, a first multiplexer 752, and a second multiplexer 792. As discussed further below, operations of the first slicer 720 and the second slicer 760 are timed based on the half-rate clock signal Clk and operations of the demultiplexers 730 and 770 and the multiplexers 752 and 792 are timed based on a quarter-rate clock signal. As discussed further below, the quarter-rate clock signal allows the demultiplexers 730 and 770 and the multiplexers 752 and 792 to operate at a lower speed. The lower speed of operation simplifies clock delivery and distribution.

The first slicer 720 has a data input 722, a feedback input 724, and an output 726. The data input 722 is coupled to the input 708 of the decision feedback equalizer 710 to receive incoming symbols (e.g., from the link 130). As discussed further below, the feedback input 724 is configured to receive previous bit decisions to perform decision feedback equalization. The feedback input 724 may be a differential input.

The second slicer 760 has a data input 762, a feedback input 764, and an output 766. The data input 762 is coupled to the input 708 of the decision feedback equalizer 710 to receive incoming symbols (e.g., from the link 130). As discussed further below, the feedback input 764 is configured to receive previous bit decisions to perform decision feedback equalization. The feedback input 764 may be a differential input.

In the example shown in FIG. 7, the half-rate clock signal Clk is input to the first slicer 720 and the inverse half-rate clock signal Clk is input to the second slicer 760. This causes the first slicer 720 and the second slicer 760 to process the incoming symbols in a time alternating fashion in which the first slicer 720 processes even symbols and the second slicer 760 processes odd symbols, or vice versa.

The first demultiplexer 730 has an input 732, a first output 734, and a second output 736. The input 732 is coupled to the output 726 of the first slicer 720, the first output 734 is coupled to the first output 712 of the decision feedback equalizer 710, and the second output 736 is coupled to the second output 714 of the decision feedback equalizer 710. The input 732 may be a differential input and each of the outputs 734 and 736 may be a differential output. The first demultiplexer 730 operates at a quarter clock rate and is configured to receive bit decisions from the output 726 of the first slicer 720 and alternately output the bit decisions at the first output 734 and the second output 736 of the first demultiplexer 730.

The second demultiplexer 770 has an input 772, a first output 774, and a second output 776. The input 772 is coupled to the output 766 of the second slicer 760, the first output 774 is coupled to the third output 716 of the decision feedback equalizer 710, and the second output 776 is coupled to the fourth output 718 of the decision feedback equalizer 710. The input 772 may be a differential input and each of the outputs 774 and 776 may be a differential output. The second demultiplexer 770 operates at a quarter clock rate and is configured to receive bit decisions from the output 766 of the second slicer 760 and alternately output the bit decisions at the first output 774 and the second output 776 of the second demultiplexer 770.

The first multiplexer 752 has a first input 754, a second input 756, and an output 758. The first input 754 is coupled to the first output 774 of the second demultiplexer 770, the second input 756 is coupled to the second output 776 of the second demultiplexer 770, and the output 758 is coupled to the feedback input 724 of the first slicer 720. Each of the inputs 754 and 756 may be a differential input and the output 758 may be a differential output. The first multiplexer 752 is configured to alternately couple the first output 774 and the second output 776 of the second demultiplexer 770 to the feedback input 724 of the first slicer 720 to provide previous bit decisions for the first slicer 720.

The second multiplexer 792 has a first input 794, a second input 796, and an output 798. The first input 794 is coupled to the first output 734 of the first demultiplexer 730, the second input 796 is coupled to the second output 736 of the first demultiplexer 730, and the output 798 is coupled to the feedback input 764 of the second slicer 760. Each of the inputs 794 and 796 may be a differential input and the output 798 may be a differential output. The second multiplexer 792 is configured to alternately couple the first output 734 and the second output 736 of the first demultiplexer 730 to the feedback input 764 of the second slicer 760 to provide previous bit decisions for the second slicer 760.

In this example, the decision feedback equalizer 710 alternately outputs even bits at the first output 712 and the second output 714 (labeled “d_even1” and “d_even2”, respectively), as shown in FIG. 7. Each of the outputs 712 and 714 may output one respective even bit for every four UIs. The decision feedback equalizer 710 also alternately outputs odd bits at the third output 716 and the fourth output 718 labeled “d_odd1” and “d_odd2”, respectively), as shown in FIG. 7. Each of the outputs 716 and 718 may output one respective odd bit for every four UIs. For example, during a first UI, the first output 712 may output a respective even bit, during a second UI, the third output 716 may output a respective odd bit, during a third UI, the second output 714 may output a respective even bit, and during the fourth UI, the fourth output 718 may output a respective odd bit. The bits from the decision feedback equalizer 710 may be output to a processor or another circuit (e.g., deserializer) for further processing.

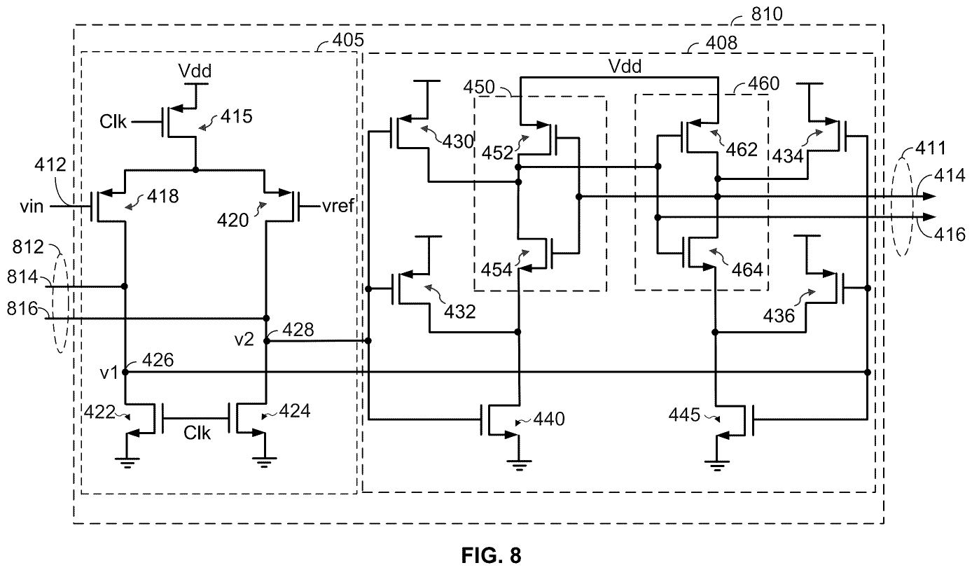

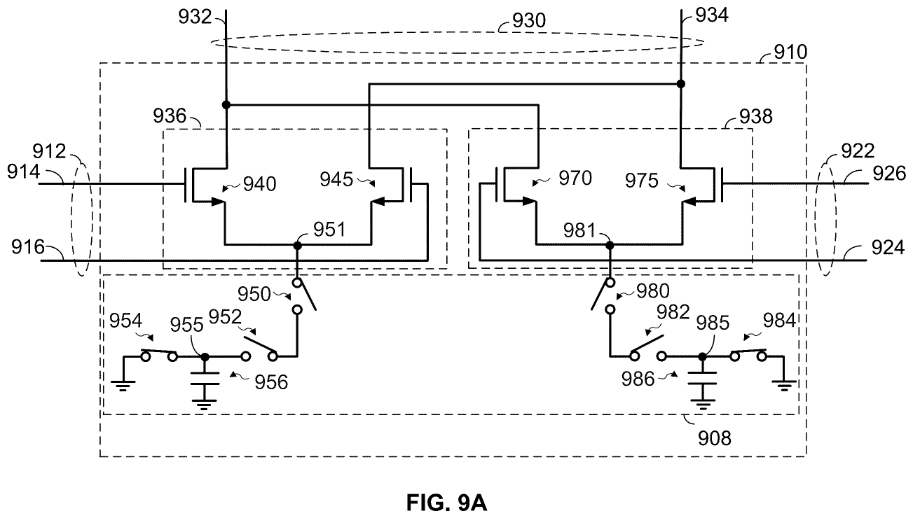

FIG. 8 shows an exemplary implementation of a slicer 810 according to certain aspects. Each of the first slicer 720 and the second slicer 760 may be implemented with the slicer 810 (i.e., each of the first slicer 720 and the second slicer 760 may be a separate instance of the slicer 810).

In this example, the slicer 810 includes the input stage 405 and the regeneration stage 408 of the slicer 410 shown in FIG. 4. For brevity, the description of the input stage 405 and the regeneration stage 408 are not repeated here. In this example, the slicer 810 has a differential feedback input 812 including a first feedback input 814 and a second feedback input 816. The first feedback input 814 is coupled to the first node 426 and the second feedback input 816 is coupled to the second node 428. In this example, the feedback of the previous bit decision is applied directly to the first node 426 and the second node 428 of the input stage 405. This relaxes loop timing constants and enables the decision feedback equalizer 710 to operate at higher data rates compared with conventional approaches. In conventional approaches, the feedback is applied to the gates of series or parallel devices before the slicer is 810 is clocked whereas applying the feedback directly to the nodes 426 and 428 removes this constraint.

For the example where the slicer 810 implements the first slicer 720, the input 412 corresponds to the data input 722, the differential feedback input 812 corresponds to the feedback input 724, and the differential output 411 corresponds to the output 726. For the example where the slicer 810 implements the second slicer 760, the input 412 corresponds to the data input 762, the differential feedback input 812 corresponds to the feedback input 764, and the differential output 411 corresponds to the output 766.

Returning to FIG. 7, in this example, the first demultiplexer 730 includes a first switch 738, a second switch 740, a first latch 742, and a second latch 745. The first latch 742 has an input 744 and an output 746. The first switch 738 is coupled between the output 726 of the first slicer 720 and the input 744 of the first latch 742. The output 746 of the first latch 742 is coupled to the first output 712 of the decision feedback equalizer 710. The second latch 745 has an input 748 and an output 750. The second switch 740 is coupled between the output 726 of the first slicer 720 and the input 748 of the second latch 745. The output 750 of the second latch 745 is coupled to the second output 714 of the decision feedback equalizer 710.

Each of the latches 742 and 745 may be implemented with the exemplary CS latch 510 shown in FIGS. 5A and 5B. For the example where the CS latch 510 implements the first latch 742, the differential input 512 corresponds to the input 744 and the differential output 520 corresponds to the output 746. For the example where the CS latch 510 implements the second latch 745, the differential input 512 corresponds to the input 748 and the differential output 520 corresponds to the output 750. In this example, each latch 742 and 745 outputs a bit decision at the respective differential output in the form of a differential voltage in which the polarity of the differential voltage represents the respective bit value. As discussed above, the CS latch 510 does not require a full output voltage swing, which consumes less power and can operate faster.

In certain aspects, the first latch 742 and the second latch 745 may be clocked by quarter-rate clock signals that are 180 degrees out of phase such that the first latch 742 and the second latch 745 alternately sample bit decisions from the output 726 of the first slicer 720. In this example, the switches 738 and 740 may alternately couple the output 726 of the first slicer 720 to the input 744 of the first latch 742 and the input 748 of the second latch 745.

In this example, the second demultiplexer 770 includes a third switch 778, a fourth switch 780, a third latch 782, and a fourth latch 785. The third latch 782 has an input 784 and an output 786. The third switch 778 is coupled between the output 766 of the second slicer 760 and the input 784 of the third latch 782. The output 786 of the third latch 782 is coupled to the third output 716 of the decision feedback equalizer 710. The fourth latch 785 has an input 788 and an output 790. The fourth switch 780 is coupled between the output 766 of the second slicer 760 and the input 788 of the fourth latch 785. The output 790 of the fourth latch 785 is coupled to the fourth output 718 of the decision feedback equalizer 710.

Each of the latches 782 and 785 may be implemented with the exemplary CS latch 510 shown in FIGS. 5A and 5B. For the example where the CS latch 510 implements the third latch 782, the differential input 512 corresponds to the input 784 and the differential output 520 corresponds to the output 786. For the example where the CS latch 510 implements the fourth latch 785, the differential input 512 corresponds to the input 788 and the differential output 520 corresponds to the output 790. In this example, each latch 782 and 785 outputs a bit decision at the respective differential output in the form of a differential voltage in which the polarity of the differential voltage represents the respective bit value.

In certain aspects, the third latch 782 and the fourth latch 785 may be clocked by quarter-rate clock signals that are 180 degrees out of phase such that the third latch 782 and the fourth latch 785 alternately sample bit decisions from the output 766 of the second slicer 760. In this example, the switches 778 and 780 may alternately couple the output 766 of the second slicer 760 to the input 784 of the third latch 782 and the input 788 of the fourth latch 785.

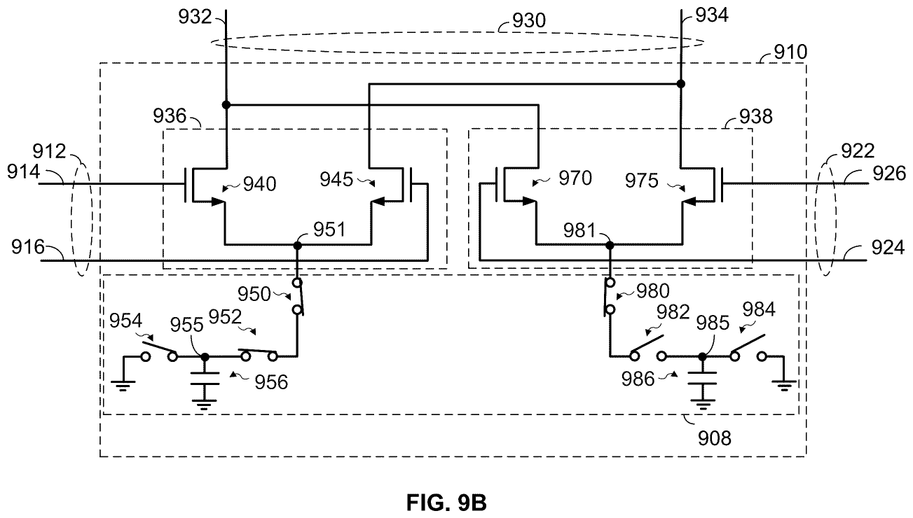

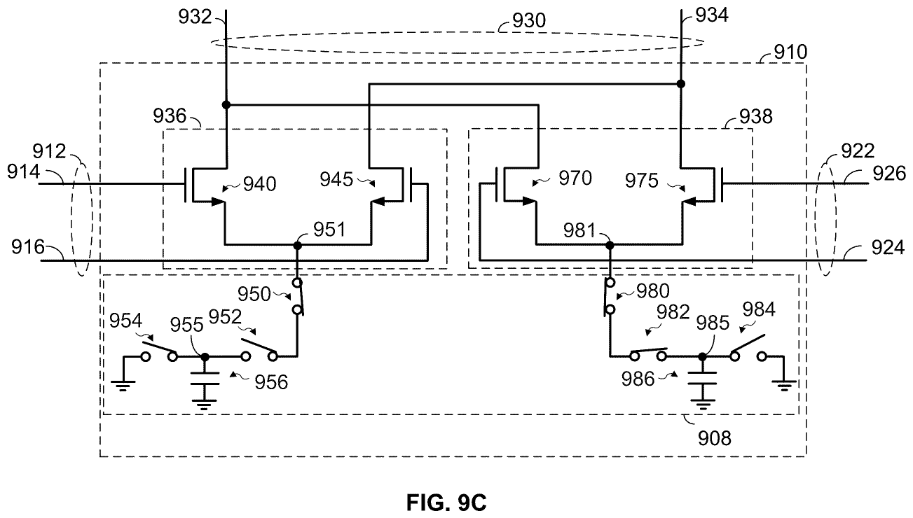

FIGS. 9A to 9C show an exemplary implementation of a charge-steering (CS) multiplexer 910 according to certain aspects. Each of the first multiplexer 752 and the second multiplexer 792 may be implemented with the CS multiplexer 910 (i.e., each of the first multiplexer 752 and the second multiplexer 792 may be a separate instance of the CS multiplexer 910).

In this example, the CS multiplexer 910 has a first differential input 912, a second differential input 922, and a differential output 930. The first differential input 912 includes a first input 914 and a second input 916, the second differential input 922 includes a third input 924 and a fourth input 926, and the differential output 930 includes a first output 932 and a second output 934. For the example where the CS multiplexer 910 implements the first multiplexer 752, the first differential input 912 corresponds to the first input 754, the second differential input 922 corresponds to the second input 756, and the differential output 930 corresponds to the output 758. For the example where the CS multiplexer 910 implements the second multiplexer 792, the first differential input 912 corresponds to the first input 794, the second differential input 922 corresponds to the second input 796, and the differential output 930 corresponds to the output 798.

In this example, the CS multiplexer 910 includes a first differential pair of transistors 936, a second differential pair of transistors 938, and a select circuit 908 configure to enable one of the first differential pair of transistors 936 and the second differential pair of transistors 938 at a time. The first differential pair of transistors 936 includes a first input transistor 940 and a second input transistor 945. The second differential pair of transistors 938 includes a third input transistor 970 and a fourth input transistor 975. In the example shown in FIGS. 9A to 9C, the selection circuit 908 includes a first switch 950, a second switch 952, a third switch 954, a first capacitor 956, a fourth switch 980, a fifth switch 982, a sixth switch 984, and a second capacitor 986.

The gate of the first input transistor 940 is coupled to the first input 914 and the drain of the first input transistor 940 is coupled to the first output 932. The gate of the second input transistor 945 is coupled to the second input 916 and the drain of the second input transistor 945 is coupled to the second output 934. The sources of the input transistors 940 and 945 are coupled to a common node 951. The first switch 950 and the second switch 952 are coupled in series between the node 951 and node 955, the first capacitor 956 is coupled between the node 955 and ground, and the third switch 954 is couped between the node 955 and ground.

The gate of the third input transistor 970 is coupled to the third input 924 and the drain of the third input transistor 970 is coupled to the first output 932. The gate of the fourth input transistor 975 is coupled to the fourth input 926 and the drain of the fourth input transistor 975 is coupled to the second output 934. The sources of the input transistors 970 and 975 are coupled to a common node 981. The fourth switch 980 and the fifth switch 982 are coupled in series between the node 981 and node 985, the second capacitor 986 is coupled between the node 985 and ground, and the sixth switch 984 is couped between the node 985 and ground.

Exemplary operations of the CS multiplexer 910 will now be discussed according to certain aspects.

FIG. 9A shows an example of the CS multiplexer 910 during a reset phase. During the reset phase, the switches 950, 952, 980, and 982 are turned off (i.e., open) and the switches 954 and 984 are turned on (i.e., closed). As a result, the capacitors 956 and 986 are discharged to ground.

FIG. 9B shows an example of the CS multiplexer 910 during a first select mode, during which the selection circuit 908 enables the first differential pair of transistors 936 to select the first differential input 912. For the example of the first multiplexer 752, the output 786 of the third latch 782 is selected and drives the first differential pair of transistors 936. For the example of the second multiplexer 792, the output 746 of the first latch 742 is selected and drives the first differential pair of transistors 936.

During the first select mode, the switches 950, 952, and 980 are turned on (i.e., closed) and the switches 954, 982, and 984 are turned off (i.e., open). As a result, the sources of the first input transistor 940 and the second input transistor 945 are coupled to the first capacitor 956 and the sources of the third input transistor 970 and the fourth input transistor 975 are decoupled from the second capacitor 986. For the example where the first output 932 and the second output 934 are coupled to the first node 426 and the second node 428, respectively, of the slicer 810, the first input transistor 940 draws a current from the first node 426 and the second input transistor 945 draw a current from the second node 428 of the slicer 810 based on the differential voltage at the first differential input 912. The current of the first input transistor 940 is greater than or less than the current of the second input transistor 945 depending on the polarity of the differential voltage, which represents the bit value of the previous bit decision (e.g., from the first latch 742 or the third latch 782). Thus, the input transistors 940 and 945 draw more current from the first node 426 or the second node 428 depending on the previous bit decision, thereby providing the slicer 810 with feedback of the previous bit decision.

FIG. 9B shows an example of the CS multiplexer 910 during a second select mode, during which the selection circuit 908 enables the second differential pair of transistors 938 to select the second differential input 922. For the example of the first multiplexer 752, the output 790 of the fourth latch 785 is selected and drives the second differential pair of transistors 938. For the example of the second multiplexer 792, the output 750 of the second latch 745 is selected and drives the second differential pair of transistors 938.

During the second select mode, the switches 950, 980, and 982 are turned on (i.e., closed) and the switches 952. 954, and 984 are turned off (i.e., open). As a result, the sources of the third input transistor 970 and the fourth input transistor 975 are coupled to the second capacitor 986 and the sources of the first input transistor 940 and the second input transistor 945 are decoupled from the first capacitor 956. For the example where the first output 932 and the second output 934 are coupled to the first node 426 and the second node 428, respectively, of the slicer 810, the third input transistor 970 draws a current from the first node 426 and the fourth input transistor 975 draw a current from the second node 428 of the slicer 810 based on the differential voltage at the second differential input 922. The current of the third input transistor 970 is greater than or less than the current of the fourth input transistor 975 depending on the polarity of the differential voltage, which represents the bit value of the previous bit decision (e.g., from the second latch 745 or the fourth latch 785). Thus, the input transistors 970 and 975 draw more current from the first node 426 or the second node 428 depending on the previous bit decision, thereby providing the slicer 810 with feedback of the previous bit decision.

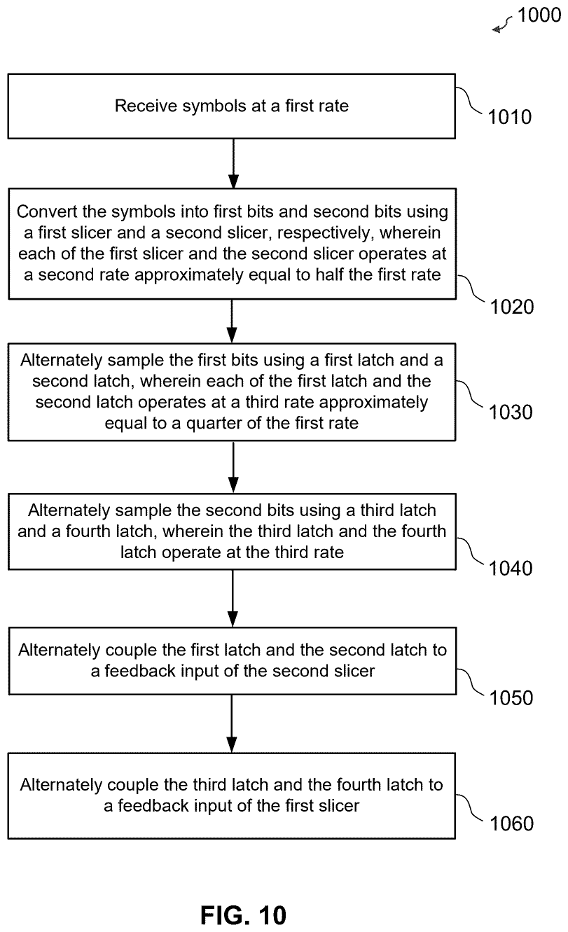

FIG. 10 illustrates a method 1000 of decision feedback equalization according to certain aspects.

At block 1010, symbols are received at a first rate. For example, the symbols may be received from the link 130.

At block 1020, the symbols are converted into first bits and second bits using a first slicer and a second slicer, respectively, wherein each of the first slicer and the second slicer operates at a second rate approximately equal to half the first rate. For example, the first slicer may correspond to the first slicer 72 0 and the second slicer may correspond to the second slicer 760.

At block 1030, the first bits are alternately sampled using a first latch and a second latch, wherein each of the first latch and the second latch operates at a third rate approximately equal to a quarter of the first rate. For example, the first latch may correspond to the first latch 742 and the second latch may correspond to the second latch 745.

At block 1040, the second bits are alternately sampled using a third latch and a fourth latch, wherein each of the third latch and the fourth latch operates at the third rate. For example, the third latch may correspond to the third latch 782 and the fourth latch may correspond to the fourth latch 785.

At block 1050, the first latch and the second latch are alternately coupled to a feedback input of the second slicer. For example, the second multiplexer 792 may alternately couple to the first latch and the second latch to the feedback input (e.g., feedback input 764) of the second slicer.

At block 1060, the third latch and the fourth latch are alternately coupled to a feedback input of the first slicer. For example, the first multiplexer 752 may alternately couple to the third latch and the fourth latch to the feedback input (e.g., feedback input 724) of the first slicer.

In certain aspects, converting the symbols into the first bits and the second bits using the first slicer and the second slicer, respectively, includes converting even ones of the symbols into the first bits using the first slicer, and converting odd ones of the symbols into the second bits using the second slicer.

In certain aspects, alternately coupling the first latch and the second latch to the feedback input of the second slicer includes alternatively driving internal nodes (e.g., nodes 426 and 428) of the second slicer using a first differential pair of transistors (e.g., the first differential pair of transistors 936) based on an output of the first latch and a second differential pair of transistors (e.g., the second differential pair of transistors 938) based on an output of the second latch.

Implementation examples are described in the following numbered clauses:
1. A decision feedback equalizer (DFE), comprising:
   a first slicer having a data input, a feedback input, and an output, wherein the data input of the first slicer is coupled to an input of the DFE;
   a first demultiplexer having an input, a first output, and a second output, wherein the input of the first demultiplexer is coupled to the output of the first slicer;
a second slicer having a data input, a feedback input, and an output, wherein the data input of the second slicer is coupled to the input of the DFE;
   a second demultiplexer having an input, a first output, and a second output, wherein the input of the second demultiplexer is coupled to the output of the second slicer;
   a first multiplexer having a first input, a second input, and an output, wherein the first input of the first multiplexer is coupled to the first output of the second demultiplexer, the second input of the first multiplexer is coupled to the second output of the second demultiplexer, and the output of the first multiplexer is coupled to the feedback input of the first slicer; and
   a second multiplexer having a first input, a second input, and an output, wherein the first input of the second multiplexer is coupled to the first output of the first demultiplexer, the second input of the second multiplexer is coupled to the second output of the first demultiplexer, and the output of the second multiplexer is coupled to the feedback input of the second slicer.
2. The DFE of clause 1, wherein the first slicer is clocked based on a first clock signal, and the second slicer is clocked based on a second clock signal that is approximately 180 degrees out of phase with the first clock signal.
3. The DFE of clause 2, wherein the input of the DFE is configured to receive symbols at a first frequency, and each of the first clock signal and the second clock signal has a second frequency that is approximately equal to half the first frequency.
4. The DFE of any one of clauses 1 to 3, wherein the first demultiplexer comprises:
   a first latch coupled to the first output of the first demultiplexer; and
   a second latch coupled to the second output of the first demultiplexer, wherein the first latch and the second latch are configured to alternately sample the output of the first slicer.
5. The DFE of clause 4, wherein the input of the DFE is configured to receive symbols at a first rate, the first slicer is configured to operate at a second rate that is approximately equal to half the first rate, and each of the first latch and the second latch is configured to operate at a third rate approximately equal to a quarter of the first rate.
6. The DFE of clause 4 or 5, wherein the first latch comprises a first charge-steering (CS) latch and the second latch comprises a second CS latch. 7. The DFE of any one of clauses 4 to 6, wherein the second demultiplexer comprises:
   a third latch coupled to the first output of the second demultiplexer; and
   a fourth latch coupled to the second output of the second demultiplexer, wherein the third latch and the fourth latch are configured to alternately sample the output of the second slicer.
8. The DFE of any one of clauses 1 to 7, wherein the first slicer comprises:
   a first input transistor, wherein a gate of the first input transistor is coupled to the data input;
   a second input transistor, wherein a gate of the second input transistor is coupled to a reference voltage;
   a first switching transistor coupled between a supply rail and a source of the first input transistor and coupled between the supply rail and a source of the second input transistor;
   a second switching transistor coupled between a drain of the first input transistor and a ground; and
   a third switching transistor coupled between a drain of the second input transistor and the ground.
9. The DFE of clause 8, wherein the output of the first multiplexer comprises a differential output including a first multiplexer output and a second multiplexer output, the first multiplexer output is coupled to a first node between the drain of the first input transistor and the second switching transistor, and the second multiplexer output is coupled to a second node between the drain of the second input transistor and the third switching transistor.
10. The DFE of clause 9, wherein the first slicer further comprises a regeneration stage coupled to the first node and the second node, wherein the regeneration stage is configured to resolve a bit based on a first voltage at the first node and a second voltage at the second node, and output the bit at the output of the first slicer.
11. The DFE of clause 9 or 10, wherein the first multiplexer comprises:
   a first differential pair of transistors coupled to the first multiplexer output and the second multiplexer output, wherein the first differential pair of transistors is driven by the first output of the second demultiplexer;
   a second differential pair of transistors coupled to the first multiplexer output and the second multiplexer output, wherein the second differential pair of transistors is driven by the second output of the second demultiplexer; and
   a selection circuit configured to enable one of the first differential pair of transistors and the second differential pair of transistors at a time.
12. A method of decision feedback equalization, comprising:
   receiving symbols at a first rate;
   converting the symbols into first bits and second bits using a first slicer and a second slicer, respectively, wherein each of the first slicer and the second slicer operates at a second rate approximately equal to half the first rate;
   alternately sampling the first bits using a first latch and a second latch, wherein each of the first latch and the second latch operates at a third rate approximately equal to a quarter of the first rate;
alternately sampling the second bits using a third latch and a fourth latch, wherein each of the third latch and the fourth latch operates at the third rate;
alternately coupling the first latch and the second latch to a feedback input of the second slicer, and alternately coupling the third latch and the fourth latch to a feedback input of the first slicer.
13. The method of clause 12, wherein converting the symbols into the first bits and the second bits using the first slicer and the second slicer, respectively, comprises:
   converting even ones of the symbols into the first bits using the first slicer; and
   converting odd ones of the symbols into the second bits using the second slicer.
14. The method of clause 12 or 13, wherein each of the first latch, the second latch, the third latch, and the fourth latch comprises a respective charge-steering (CS) latch.
15. The method of any one of clauses 12 to 14, wherein alternately coupling the first latch and the second latch to the feedback input of the second slicer comprising: alternatively driving internal nodes of the second slicer using a first differential pair of transistors based on an output of the first latch and a second differential pair of transistors based on an output of the second latch.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect electrical coupling between two structures. The term “approximately” means withing a range of between 90 percent and 110 percent of the stated value. It is also to be appreciated that an output may include multiple parallel outputs, and that an input may include multiple parallel inputs. It is also to be appreciated that an output may be a single-ended output or a differential output, and an input may be a single-ended input or a differential input.

Any reference to an element herein using a designation such as “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A decision feedback equalizer (DFE), comprising:
a first slicer having a data input, a feedback input, and an output, wherein the data input of the first slicer is coupled to an input of the DFE;
a first demultiplexer having an input, a first output, and a second output, wherein the input of the first demultiplexer is coupled to the output of the first slicer;
a second slicer having a data input, a feedback input, and an output, wherein the data input of the second slicer is coupled to the input of the DFE;
a second demultiplexer having an input, a first output, and a second output, wherein the input of the second demultiplexer is coupled to the output of the second slicer;
a first multiplexer having a first input, a second input, and an output, wherein the first input of the first multiplexer is coupled to the first output of the second demultiplexer, the second input of the first multiplexer is coupled to the second output of the second demultiplexer, and the output of the first multiplexer is coupled to the feedback input of the first slicer; and
a second multiplexer having a first input, a second input, and an output, wherein the first input of the second multiplexer is coupled to the first output of the first demultiplexer, the second input of the second multiplexer is coupled to the second output of the first demultiplexer, and the output of the second multiplexer is coupled to the feedback input of the second slicer.

2. The DFE of claim 1, wherein the first slicer is clocked based on a first clock signal, and the second slicer is clocked based on a second clock signal that is approximately 180 degrees out of phase with the first clock signal.

3. The DFE of claim 2, wherein the input of the DFE is configured to receive symbols at a first frequency, and each of the first clock signal and the second clock signal has a second frequency that is approximately equal to half the first frequency.

4. The DFE of claim 1, wherein the first demultiplexer comprises:
a first latch coupled to the first output of the first demultiplexer; and
a second latch coupled to the second output of the first demultiplexer, wherein the first latch and the second latch are configured to alternately sample the output of the first slicer.

5. The DFE of claim 4, wherein the input of the DFE is configured to receive symbols at a first rate, the first slicer is configured to operate at a second rate that is approximately equal to half the first rate, and each of the first latch and the second latch is configured to operate at a third rate approximately equal to a quarter of the first rate.

6. The DFE of claim 4, wherein the first latch comprises a first charge-steering (CS) latch and the second latch comprises a second CS latch.

7. The DFE of claim 4, wherein the second demultiplexer comprises:
a third latch coupled to the first output of the second demultiplexer; and
a fourth latch coupled to the second output of the second demultiplexer, wherein the third latch and the fourth latch are configured to alternately sample the output of the second slicer.

8. The DFE of claim 1, wherein the first slicer comprises:
a first input transistor, wherein a gate of the first input transistor is coupled to the data input;
a second input transistor, wherein a gate of the second input transistor is coupled to a reference voltage;
a first switching transistor coupled between a supply rail and a source of the first input transistor and coupled between the supply rail and a source of the second input transistor;
a second switching transistor coupled between a drain of the first input transistor and a ground; and
a third switching transistor coupled between a drain of the second input transistor and the ground.

9. The DFE of claim 8, wherein the output of the first multiplexer comprises a differential output including a first multiplexer output and a second multiplexer output, the first multiplexer output is coupled to a first node between the drain of the first input transistor and the second switching transistor, and the second multiplexer output is coupled to a second node between the drain of the second input transistor and the third switching transistor.

10. The DFE of claim 9, wherein the first slicer further comprises a regeneration stage coupled to the first node and the second node, wherein the regeneration stage is configured to resolve a bit based on a first voltage at the first node and a second voltage at the second node, and output the bit at the output of the first slicer.

11. The DFE of claim 9, wherein the first multiplexer comprises:
a first differential pair of transistors coupled to the first multiplexer output and the second multiplexer output, wherein the first differential pair of transistors is driven by the first output of the second demultiplexer;
a second differential pair of transistors coupled to the first multiplexer output and the second multiplexer output, wherein the second differential pair of transistors is driven by the second output of the second demultiplexer; and
a selection circuit configured to enable one of the first differential pair of transistors and the second differential pair of transistors at a time.

12. A method of decision feedback equalization, comprising:
receiving symbols at a first rate;
converting the symbols into first bits and second bits using a first slicer and a second slicer, respectively, wherein each of the first slicer and the second slicer operates at a second rate approximately equal to half the first rate;
alternately sampling the first bits using a first latch and a second latch, wherein each of the first latch and the second latch operates at a third rate approximately equal to a quarter of the first rate;
alternately sampling the second bits using a third latch and a fourth latch, wherein each of the third latch and the fourth latch operates at the third rate;
alternately coupling the first latch and the second latch to a feedback input of the second slicer, and
alternately coupling the third latch and the fourth latch to a feedback input of the first slicer.

13. The method of claim 12, wherein converting the symbols into the first bits and the second bits using the first slicer and the second slicer, respectively, comprises:
converting even ones of the symbols into the first bits using the first slicer; and
converting odd ones of the symbols into the second bits using the second slicer.

14. The method of claim 12, wherein each of the first latch, the second latch, the third latch, and the fourth latch comprises a respective charge-steering (CS) latch.

15. The method of claim 12, wherein alternately coupling the first latch and the second latch to the feedback input of the second slicer comprising:
alternatively driving internal nodes of the second slicer using a first differential pair of transistors based on an output of the first latch and a second differential pair of transistors based on an output of the second latch.
